(19) United States
(12) Patent Application Publication
(10) Pub. No.: US 2002/0100237 A1
(43) Pub. Date: Aug. 1, 2002

(54) Tile simulating four tiles with a reticulated mesh support and free assembly

(76) Inventor: Pablo Casanova Ramon-Borja, Valencia (ES)

Correspondence Address: Penrose Lucas Albright, Esq., MASON, MASON & ALBRIGHT, 2306 South Eads Street, P.O. Box 2246, Arlington, VA, 22202-0246, US

(21) Appl. No.: 09/985,961

(22) Filed: Nov. 5, 2001

Related U.S. Application Data
(63) Continuation of application No. PCT/ES01/00082, filed on Mar. 5, 2001.

(30) Foreign Application Priority Data
Mar. 6, 2000 (ES) U 200000590

(51) Int. Cl. E04C 1/00; B44F 7/00; B44F 9/00; E04D 1/00

(52) U.S. Cl. 52/314; 52/518

(57) ABSTRACT

A tile simulating four tiles having a reticulated mesh support and free assembly, which forms on a single piece two longitudinally superimposed ridge tiles and two adjacent channel tiles that are also superimposed and which are concave on the top face and have a flat support on the bottom face. The longitudinal side of the channel tiles has a flat area in an ascending oblique position. Both the concave area and the flat area on the bottom face have lugs with a trapezoidal section serving as support on the cover. The tile has a posterior peripheral ridge ending in an edge with a descending step at the height in which superimposition of the tiles is simulated. The flat area on the perimeter has a peripheral edge and other vertical ridges extending parallel to the edge and interrupted by oblique channels.

Tile simulating four tiles with a reticulated mesh support and free assembly”, in such a manner that by placing one unit, the effect of placing four single tiles is created.

The effect achieved in this invention is that of two ridge tiles and two channel tiles, all adjacent to each other. The channel tiles are concave shaped on the upper face, although the bottom face support is flat and mesh shaped.

The advantages of this invention can be easily discerned from the present description, in any case, we enumerate its essential characteristics merely as quote and without any limitative effect, to be noted;

The support in the shape of reticulated mesh provides the following advantages:

it facilitates the ventilation of the bottom face of the tiles on the roof, leaving some airtight compartments in the shape of air chambers. Good ventilation is necessary in ceramic material, this way dampness and condensation is avoided and better quality and durability is achieved in the covering, both in the support and the tiles.

the air chamber provides better thermal and acoustic insulation.

horizontal support gives better stability, for its placement on the roof.

greater adherence to the support, facilitates the fastening of the tiles.

the mesh also facilitates the manufacturing of the tiles in series, given that it improves the airing of the tiles in both the drying room and the kiln.

because of the horizontal support, this tile can be manufactured in the same tray as standard tiles.

the support is reinforced with ribs, which provide greater rigidity, resistance to flexopressure compression and impact.

Free assembly allows for the following advantages:

greater speed and velocity of placement.

possibility of laying the tiles on roofs in shifting squares or circularly.

dry finishing of the roof (without mortar).

For a better understanding of this statement, the following drawings are included, which serve as a non limiting example of the realization of the object of this invention, in which:

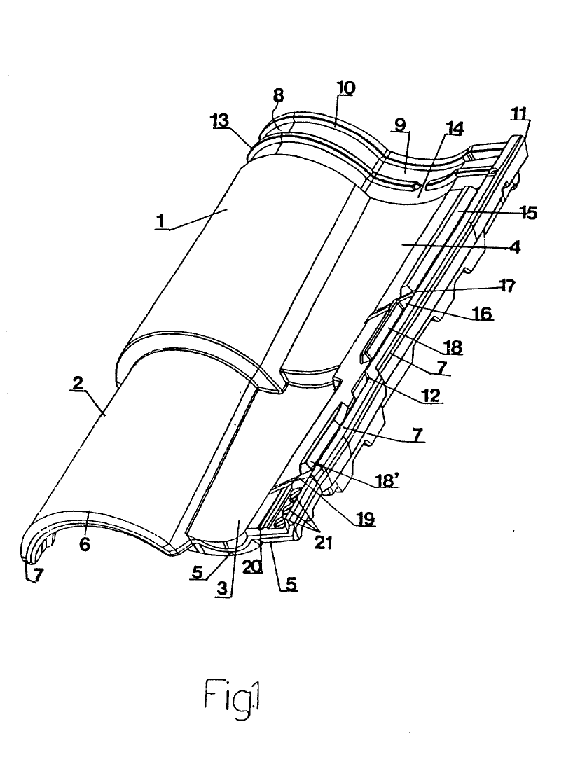

FIG. 1 is a perspective view of the top face of the tile.

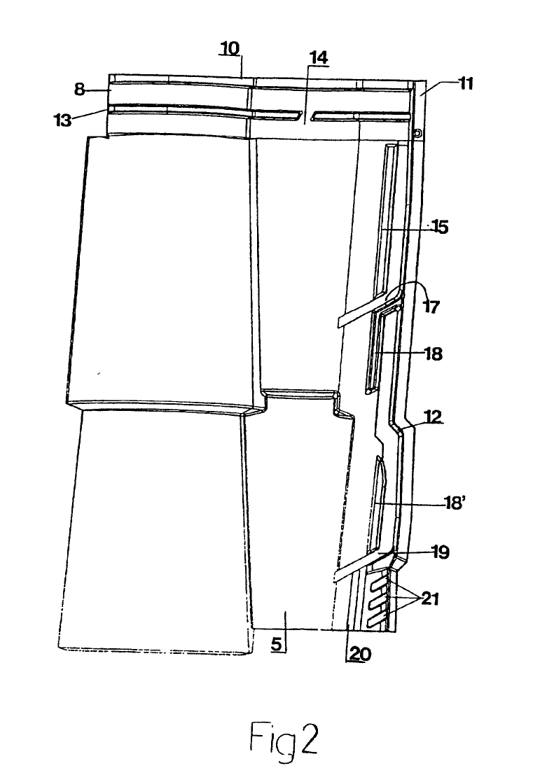

FIG. 2 is a plan-view of the top face of the tile.

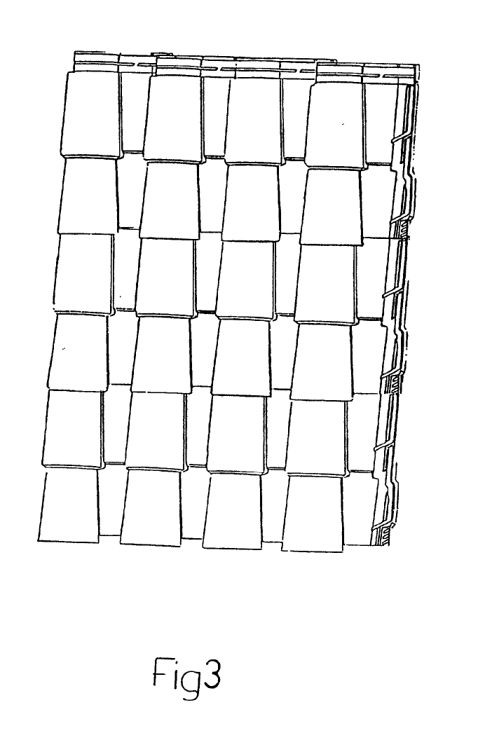

FIG. 3 is an elevated plan-view of a cover where this tile has been assembled.

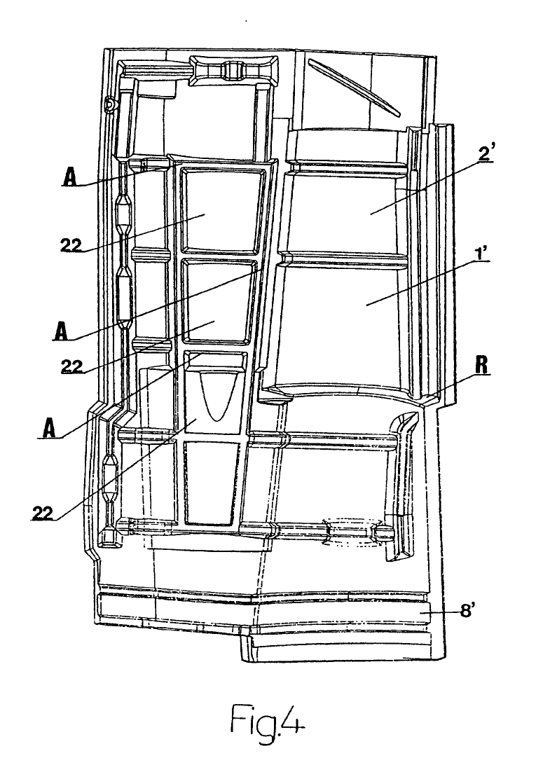

FIG. 4 is a view of the bottom face of the tile in relief.

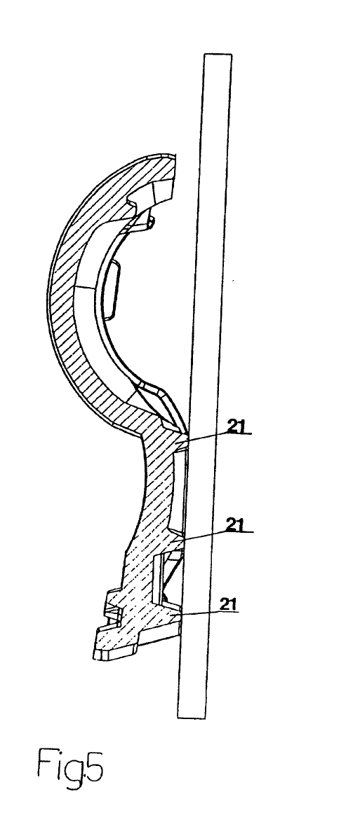

FIG. 5 is a cut view of the tile situated on the cover.

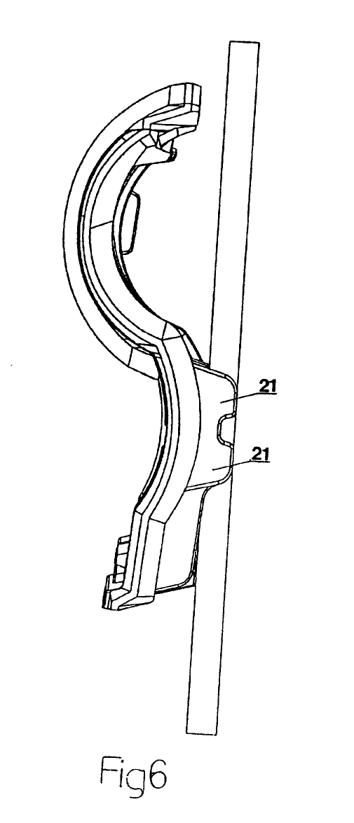

FIG. 6 is a rear view of the assembled tile.

FIG. 7 is an elevated view of the tile just as it is manufactured in the tray.

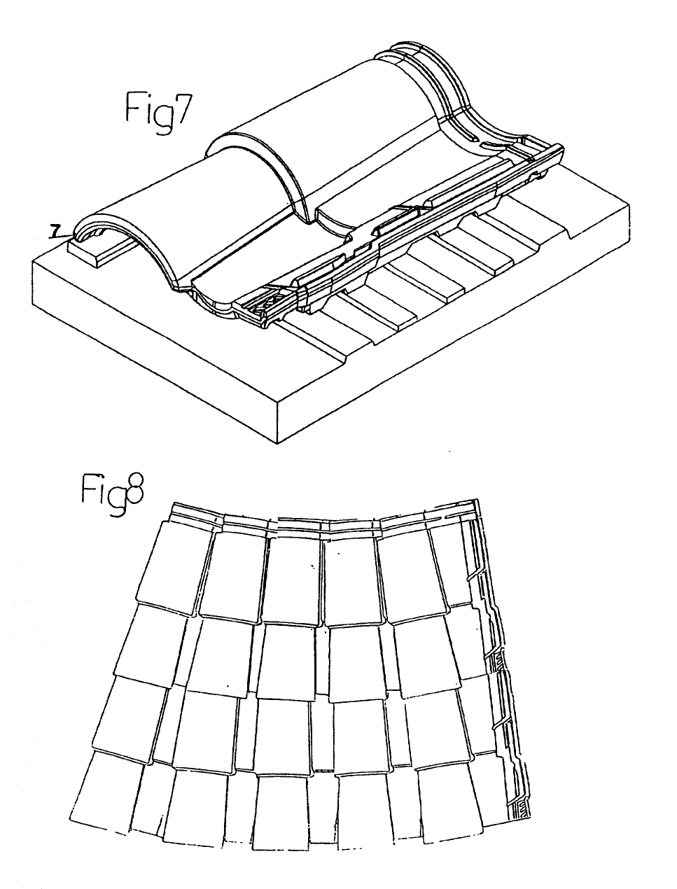

FIG. 8 is a view of the tiles, subject of this Model, on a circular cover.

In accordance with this invention, the tile consists of two semi-cylindrical areas (1 and 2) which are convexedly superimposed, longitudinally adjacent with channelled concave areas (3 and 4) superimposed as well. The latter have a flat bottom support (5). The front edge (6) of the tile has a protruding peripheral (7) step. In the rear, the tile has convex (8) and concave (9) channelled zones slightly lower in height with respect to the rest of the tile and with a posterior peripheral ridge (10) that ends in a longitudinal edge (11). At the height that simulates the superimposition of the tiles it has an undercutting or descending step (12).

In the middle of the width of this posterior undercutting (8) there is another step (13) similar in height and parallel to the peripheral one. The former has a channel (14) in the centre of the concave area (9).

At the same time, on the inside of the peripheral longitudinal step(11) there is another step (15) with a trapezoidal section and with an approximate length of ⅔ of the adjacent concave area length.

Next to it there is a channel (16)with a slight transversal protrusion (17).

There is another longitudinal protrusion (18) with a trapezoidal section of shorter length which reaches the zone that simulates the superimposition of the tiles where the peripheral edge presents a descending step (12) which has before been mentioned. Inside there is another step (18′) similar to those previously described, and of a greater height at the peripheral edge, thus creating a slight oblique transversal rim (19).

The front part of this flat zone is divided longitudinally by the channel (20) and the most outer part is composed of three oblique steps which are parallel to each other (2).

The front edge (7) occupies the entire front parameter and the longitudinal side of the tile.

On the bottom face, the concave area as well as the flat periphery have lugs with a trapezoidal section (21) which serves as a support on the cover.

FIG. 4 shows a bottom view with peripheral relieves (R) of the flat areas (8′, 1′, 2′) which correspond to the bottom face of the convex areas that serve as support to the latter.

The areas which on the top face are concave and flat form a mesh with supports in the peripheral ribs (A) and rectangular spaces (22) determined by the above mentioned ribs which allow for the support of the edges and the ribs that protrude as well as for the creation of air chambers which improve the ventilation and avoid dampness.

1.- “Tile simulating four tiles with a reticulated mesh support and free assembly”, which is composed of two semi-cylindrical areas (1 and 2) superimposed convexedly between each other, longitudinally adjacent with channelled concave areas (3 and 4) which are also superimposed. The latter have a flat bottom support (5).
The front edge (6) of the tile has a peripheral protruding step(7).
The front edge (7) occupies the entire front perimeter and the longitudinal edge of the tile.
In its rear, the tile has convex (8) and concave (9) channel zones slightly lower in height in comparison to the rest of the tile, which has a peripheral posterior step (10), which ends in a longitudinal ridge (11). When this ridge reaches the height that simulates the superimposition of the tiles, there is an undercutting or descending step (12).
In the middle of the width of this posterior undercutting (8) there is another step (13) similar in height and parallel to the peripheral one which is provided with a channel (14) in the centre of the concave area (9).
At the same time, on the inside of the peripheral longitudinal step (11) there is another step (15) with a trapezoidal section and with an approximate length which is ⅔ of the adjacent concave area length. Next to it there is a channel (16) with a slight transversal protrusion (17).
There is always another longitudinal protrusion (18) with a trapezoidal section of shorter length which reaches the zone that simulates the superimposition of the tiles where the peripheral edge presents a descending step (12) which has been mentioned before. Inside there is another step (18′) similar to those previously described, and of a greater height at the peripheral edge, thus creating a slight oblique transversal rim (19).
The front part of this flat zone is divided longitudinally by the channel (20) and the most outer part is composed of three oblique steps which are parallel to each other (2).
On the bottom face, the concave area as well as the flat periphery have lugs with a trapezoidal section (21) which serves as a support on the cover.

2.- “Tiles simulating four tiles with a reticulated mesh support and free assembly”, according to claim 1, characterized in that the bottom face of the tile shows peripheral relieves (R) of the flat areas (8′, 1′, 2′) which correspond to the bottom face of the convex areas that serve as support to the latter.
The areas which on the top face are concave and also flat form a mesh with supports in the peripheral ribs (A) and rectangular spaces (22) determined by the above mentioned ribs which allow for the support of the edges and the ribs that protrude as well as for the creation of air chambers which improve the ventilation and avoid dampness.
